(19) United States
(12) Patent Application Publication
(10) Pub. No.: US 2008/0074558 A1
(43) Pub. Date: Mar. 27, 2008

(54) Broadcasting receiver

(75) Inventors: Hideaki Watanabe, Shijonawate City (JP); Masako Wakisaka, Osaka City (JP)

Correspondence Address: MASUVALLEY & PARTNERS, 8765 AERO DRIVE, SUITE 312, SAN DIEGO, CA, 92123, US

(73) Assignee: Sanyo Electric Co., Ltd., Moriguchi-City (JP)

(21) Appl. No.: 11/903,706

(22) Filed: Sep. 24, 2007

(30) Foreign Application Priority Data
Sep. 25, 2006 (JP) 2006-259817

(51) Int. Cl. H04N 5/44

(52) U.S. Cl. 348/734; 348/E05.096

(57) ABSTRACT

An objective of the present invention is to present a broadcasting receiver with a channel setting condition in a channel preset setting and a channel skip setting that is easy to understand to a user. In the present invention, both of the channel preset setting to allocate a channel on a numeric key on a remote controller or a main body and the channel skip setting to exclude a channel designated to skip among receivable channels from the subject of an up/down channel selection can be performed. The screen portion reflecting the condition of allocation of a channel to each numeric key in the channel preset setting and the screen portion reflecting the condition of the skip setting to receivable channels in the channel skip setting are displayed on an identical screen.

### TECHNICAL FIELD

The present invention relates to a broadcasting receiver to receive a broadcast.

Generally, the broadcasting receiver is capable of performing both a channel preset setting to allocate channels on numeric number keys on a remote controller or a main body, and a channel skip setting to exclude a channel which is designated to skip among receivable channels from the subject of up/down channel selection (referred to the patent document 1).

[Patent document 1] Japanese Published Unexamined Patent Application No. 2003-298964

### BACKGROUND OF INVENTION

However, in a conventional broadcasting receiver, related channel preset settings and channel skip settings are performed on separate setting screens. In this way, when each setting is performed on the separate screen, for example, there is a disadvantage of having difficulty in realizing the fact that a channel is designated to skip even when the channel is also preset. Conversely, there is a disadvantage of having difficulty in realizing the fact that a channel may be preset even when the channel is also set to skip.

The present invention is made considering the above circumstance, and the objective is to provide a broadcasting receiver capable of presenting a channel setting condition in the channel preset setting and the channel skip setting that is easy to understand for a user.

### BRIEF SUMMARY OF INVENTION

In order to solve the above issues, a broadcasting receiver according to the present invention is capable of performing both a channel preset setting for allocating a channel on a numeric key on a remote controller or a main body, and a channel skip setting for excluding a channel which is designated to skip from the subject of an up/down channel selection, and the broadcasting receiver consists of a means for displaying a first listing screen display reflecting a condition of the allocation of a channel on each numeric key in the channel preset setting and a second listing display reflecting a condition of a skip setting to a channel in the channel skip setting on an identical screen, and a means for reflecting an instruction from a user on the first listing screen display and the second listing screen display while the first listing screen display and the second listing screen display are displayed.

By configuring as described above, the first listing screen display reflecting the condition of the channel allocation on each numeric key in the channel preset setting and the second listing display reflecting the condition of a skip setting to a channel in the channel skip setting are performed on an identical screen and the user instruction is reflected on the screen, thereby the channel setting condition for the channel preset setting and the channel skip setting may be presented to a user in a way that is easy to understand.

In the broadcasting receiver configured as described above, a means for displaying an electronic program guide according to the program information which shows contents of the program is provided, and the channel designated to skip may be excluded from the display subject for the electronic program guide.

In the broadcasting receiver configured as described above, a display to call an attention to a user may be made on the screen when the user designates a channel to skip in the channel skip setting while the channel is allocated to a numeric key in the channel preset setting.

In the broadcasting receiver configured as described above, a display to call an attention to a user may be made on the screen when a channel is allocated to a numeric key in the channel preset setting while the channel is designated to skip in the channel skip setting by the user.

In the configuration to call an attention, the display to call an attention may be made by changing a frame and a display within the frame to show the condition of a channel allocation to each numeric key in the first listing screen display different from the forms of other frames or displays within the frame.

In the configuration to call the attention, an audio guidance to indicate that the operation is possibly not favorable may be made along with the display to call an attention.

As explained above, the present invention has an effect of presenting the channel setting condition in the channel preset setting and the channel skip setting in a way that is easy to understand for a user.

### BRIEF DESCRIPTION OF THE DRAWINGS

FIG. 1 is a block diagram of a digital broadcasting receiver according to the present invention.

FIG. 2 is a plan view of a remote control transmitter.

FIGS. 3(a), (b), and (c) are illustrations of transitions of a menu item screen, or a setting item detail.

FIGS. 4(a), (b), and (c) are illustrations of transitions of a channel setting screen (a common screen).

FIGS. 5(a) and (b) are illustrations of transitions of a channel setting screen (a common screen).

FIGS. 6(a) and (b) are illustrations of transitions of a channel setting screen (a common screen).

FIGS. 7(a) and (b) are illustrations of transitions of a channel setting screen (a common screen).

FIGS. 8(a) and (b) are illustrations of transitions of a channel setting screen (a common screen).

FIG. 9 shows an example for a display to call an attention on a channel setting screen (common screen).

FIG. 10 is a flowchart of an example of a process detail for this embodiment.

FIGS. 11(a), (b), and (c) are illustrations of transitions of a menu item screen.

FIG. 12 is an illustration of transitions of a conventional menu item screen corresponding to the FIG. 3(b).

FIGS. 13(a), (b), and (c) are illustrations of transitions of a conventional menu item screen corresponding to FIGS. 11(a), (b), and (c).

### DETAIL DESCRIPTION OF THE INVENTION

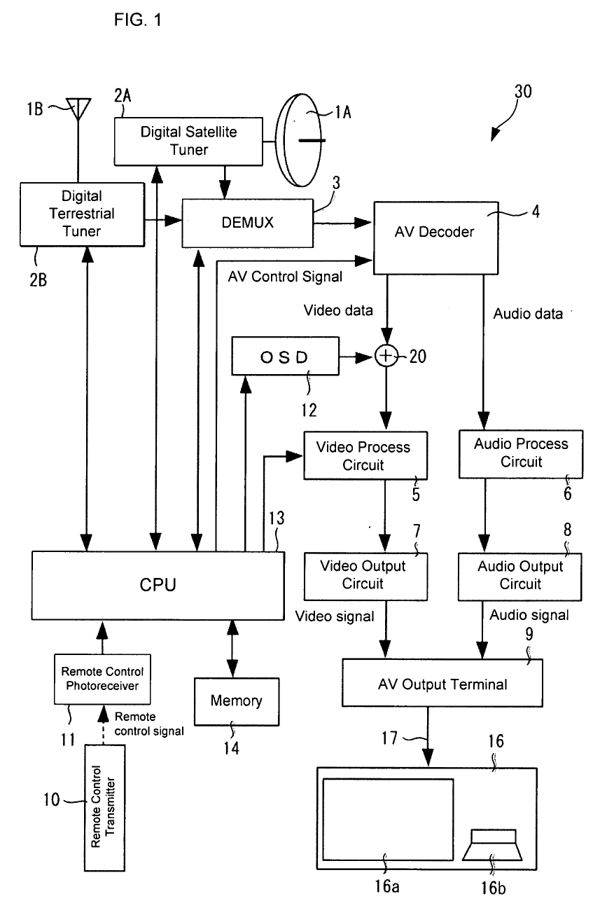

The embodiment of the present invention is hereinafter explained in detail according to FIGS. 1 to 13. FIG. 1 is a block diagram of a broadcasting receiver 30 capable of receiving both digital terrestrial broadcasting and digital satellite broadcasting signals.

An antennal 1A is arranged in a predetermined direction in the outdoors, and receives a digital broadcasting signal transmitted from CS (Communication Satellite) or BS (Broadcasting Satellite). This antenna 1A is generally provided with a frequency converter, and provides received/frequency converted signals to a digital satellite tuner 2A. Also, an antenna 1B receives a digital terrestrial broadcasting signal and provides it to a digital terrestrial tuner 2B.

The tuners 2A and 2B take out signals with a specific frequency from a high-frequency digital modulation signal including video/audio data. Also, the tuners 2A and 2B are provided with a demodulation circuit, an inverse interleave circuit, an error correction circuit, thereby demodulating the selected digital modulation signal and output transport stream.

A demultiplexer (DEMUX) 3 inputs the transport stream from the tuners 2A and 2B according to an instruction of a CPU 13, and demultiplexes into adjunctive information, such as a video stream of MPEG2 (Moving Picture Experts Group 2), an audio stream, and a PSI/SI (Program Specific Information/Service Information). The demultiplexer 3 selects video and audio streams of the digital satellite broadcast or the digital terrestrial broadcast according to an instruction of the CPU 13, and supplies them to an AV decoder 4, and supplies the CPU 13 with program information contained in the PSI/SI (such as, the name of a program, start time of the program, duration of the program, program content information, and program genre information).

The AV decoder 4 is provided with a video decoder to decode the video stream, and an audio decoder to decode the audio stream. The video decoder decodes an input variable-length code to obtain a quantized coefficient or a motion vector, thereby performing a motion-compensated control according to an invert DCT conversion or the motion vector. The audio decoder decodes an input encoding signal to generate audio data. The video data generated by decoding is output to a video process circuit 5, and the audio data is output to an audio process circuit 6.

The video process circuit 5 receives the video data from the AV decoder 4 and performs D/A conversion, and converts it into for example, a composite video signal. The audio signal process circuit 6 receives audio data output from the AV decoder 4 and performs a D/A conversion to generate, for example, a right (R) sound analog signal and a left (L) sound analog signal, and also generates analog signals of main sound and sub sound.

An video output circuit 7 and an audio output circuit 8 are provided with an output resistance, an amplifier, and so on. An AV output terminal 9 is provided with an output portion (such as a set of left right output terminals and video output terminals), a monitor 16 provided with a picture tube 16a and a speaker 16b connected to this output portion by a video/audio card 17.

An OSD (On Screen Display) circuit 12 generates video data according to character information and color information instructed to output by the CPU 13, and outputs to an adder 20. The adder 20 performs a process to incorporate the video data into the reception video data output from the AV decoder 4. This OSD circuit 12 enables the displays, such as an electronic program guide display, menu screen, and each setting screen (such as a channel setting screen).

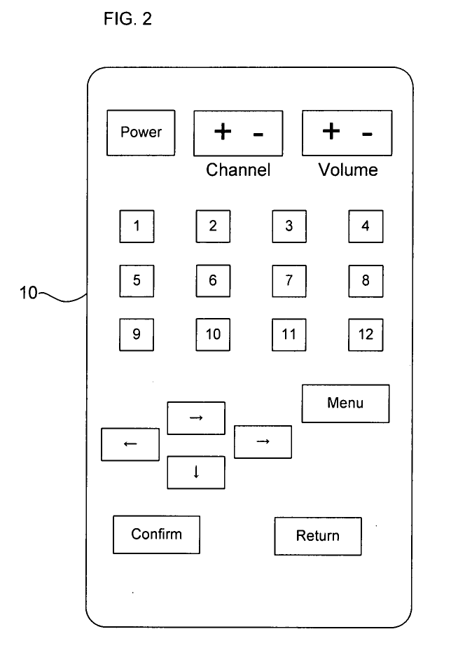

As shown in FIG. 2, a remote control transmitter (remote controller) 10 is provided with various keys to transmit various instructions to the broadcasting receiver 30, and when operating the key, a signal light (remote control signal) which means an instruction corresponding to the key, is transmitted from a light emitting portion. The remote control photoreceiver 11 receives the signal light, converts it into an electric signal, and provides to the CPU 13. In addition, in the present embodiment, the remote control transmitter 10 is provided with numeric keys “1” to “12”.

In addition to the information to display the EPG (electronic program guide), a memory (for example, RAM, EEPROM, flash memory) 14 stores channel information (frequency information, information such as a channel list corresponding to a numeric key), and various setting information.

The CPU 13 performs overall control in the digital broadcasting receiver 30, especially, an acquisition process of the channel information, the channel preset setting, the channel skip setting, and select channel processes according to the key operation of the remote control transmitter 10, as the processes according to the present invention.

(Channel Information Acquisition for Digital Terrestrial Broadcasting)

For example, when a user sets an area of residence, a reception process is performed according to the pre-stored channel setting information for each area of residence. That is, the CPU 13 automatically selects registered channels in the area of residence on the tuner 2, extracts station information (the name of the network station and so on) when receiving a broadcast wave, and stores it in the memory 14. Further, in above-described channel search, separates PSI from the transport stream of received broadcast signals, obtains remote control key IDs (TS number descriptor) of the NIT (Network Information Table) within the PSI, and coordinates with the above described frequency information and may be stored in the memory 14.

(Channel Information Acquisition for Digital Satellite Broadcasts)

In digital satellite broadcasts, the channel information (for example, the number of BS morning evening channel 1 is 100, and the information to indicate which is the transponder to such channel) may be obtained according to the above described PSI/SI.

(Channel Preset Setting)

The channel preset setting is a process to allocate a channel on a numeric key of a remote controller or a main body. In the digital terrestrial broadcasting, coordination of the position according to the remote control key ID and the broadcast to be received can be made. Of course, when a user desires to set a certain numeric key (position) for a certain broadcast, the user may change the setting. Also in the digital satellite broadcast, for example, a desired satellite broadcast (for example, BS morning evening 1) may be allocated on the numeric key “1”. In the present invention, the channel preset setting may be performed on a channel preset setting/channel skip setting common screen. This channel preset setting/channel skip setting common screen is a screen that incorporates the screen portion for the channel preset setting (first listing screen display) and the screen portion for the channel skip setting (second listing screen display) within the same screen.

(Channel Skip Setting)

The channel skip setting is a process to exclude a channel set to skip among the receivable channels from the up-down channel select. In this embodiment, the channel skip setting is performed by ticking or removing a mark (check) from a check box of the channel description portion on the channel preset setting/channel skip setting common screen. The channel removed is set to skip (excluded from the subject of channel selection).

Detail for the process is hereinafter explained.

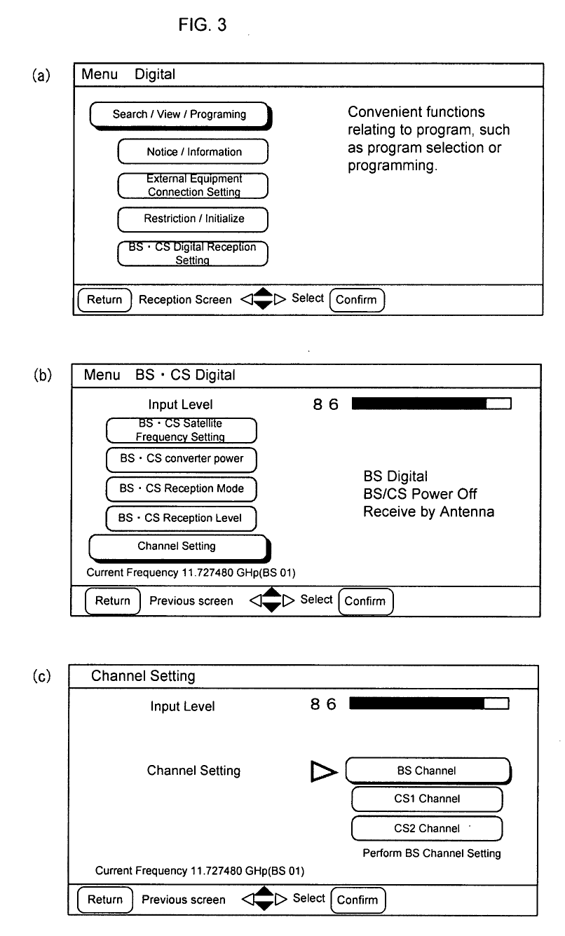

FIG. 3(a) is an illustration of a menu screen example. This menu screen is displayed when a “menu” key on the remote control transmitter 10 is pressed. In addition, this figure does not contain items relating to the digital terrestrial broadcast, and for the digital terrestrial broadcast, a digital terrestrial broadcasting menu is provided separately. Cursor expression (selection of item) is described in an enlargement of item frame and shading (pop out), however, it is not limited to this, and it may be colored in different colors from non-selected items. Also, in this embodiment, the explanation display for the item pointed by the cursor (highlighted) is made on the display.

FIG. 3(b) shows a condition that the cursor is placed on the “channel setting” among the menu items. In this condition, value information of the current receiving frequency and indicator display showing reception level (input level) are shown. When the CPU 13 detects the confirmation operation is performed in the condition of this figure, the CPU 13 displays subordinate items for the channel setting.

FIG. 3(c) shows a condition that the subordinate items for the channel setting are displayed, as well as the item “BS channel” is selected. Change of selection of items may be performed by the up/down direction key. When the CPU 13 detects the confirmation operation is performed in the condition of this figure, the CPU 13 displays the channel preset setting/channel skip setting common screen (hereinafter referred to as the common screen).

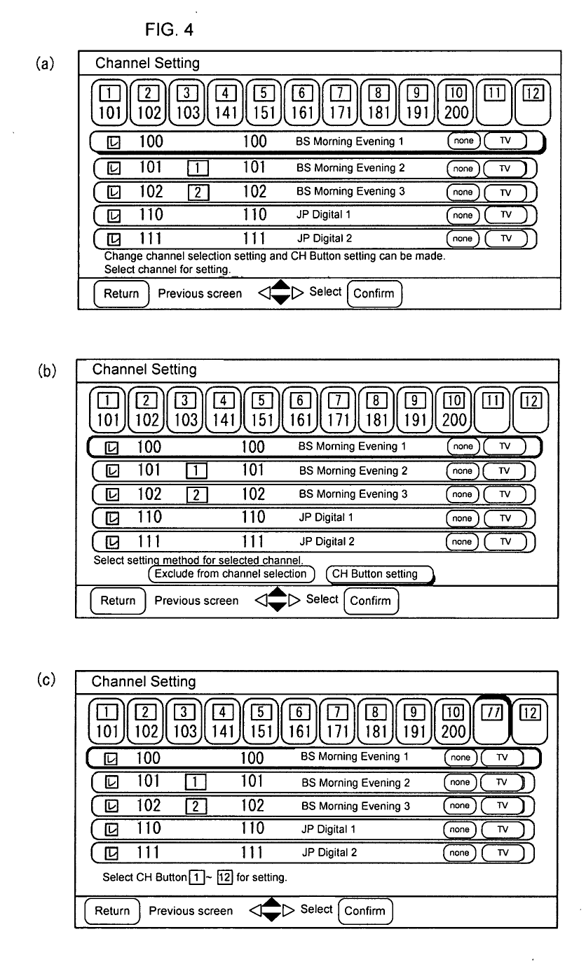

FIG. 4(a) shows a condition that the common screen is displayed. In this common screen, twelve square frames are arranged in horizontal direction and numbered “1” to “12”. Further, in the square frames, the numbers of channels coordinated (preset) to the frames are shown. That is, the area arranged above the square frames is a screen portion of the channel preset setting.

And, on the lower side of the screen portion of the channel preset setting, frames narrow in a horizontal direction (channel information description frames) are arranged vertically in the screen. The description of each narrow frame consists of a portion to describe the information obtained by the above described channel information acquisition process (a description to indicate if it is a pay program or a free program, a description to indicate if it is a TV or a radio, a channel number, and a broadcasting station), a portion to describe the information indicating the preset numeric key, and a portion to describe that the check box to indicated as to whether the preset setting is selected or not. That is, the description group of narrow frames is a channels list, as well as a screen portion of the channel skip setting. In the FIG. 4(a), the upper most narrow frame is selected as a default, however, an arbitrary narrow frame may be selected by operating the up/down direction key on the remote control transmitter 10. In addition, when the cursor is placed on the lower most narrow frame and the down direction key is pressed further, the next narrow frames will be shown by a scroll process. When the CPU 13 detects the confirmation operation is performed in the condition of FIG. 4(a), the CPU 13 switches to a screen to ask whether to exclude the channel of confirmed selected narrow frames from the channel selection subject, or to perform the setting of channel buttons (numeric keys).

FIG. 4(b) shows the screen display to ask whether to exclude the channel of confirmed selected narrow frames from the channel selection subject, or to perform the setting of channel buttons. In addition, the confirmed selection of narrow frames is indicated in a bold frame. And, a button for “remove from channel selection subject” and a button for “channel button setting” are shown. The selection of the buttons may be by a left/right direction key. In this FIG. 4(b), the button for “channel button setting” is selected, and when the CPU 13 detects the confirmation in this condition, the CPU 13 moves the cursor to the screen portion of the channel preset setting.

FIG. 4(c) shows the condition where the cursor is moved to the screen portion for the channel preset setting. In this screen, the cursor is placed on the square frame (numeric key not yet preset) of “11” as a default. By operating the left/right direction key on the remote control transmitter 10 in this condition, an arbitrary square frame may be selected.

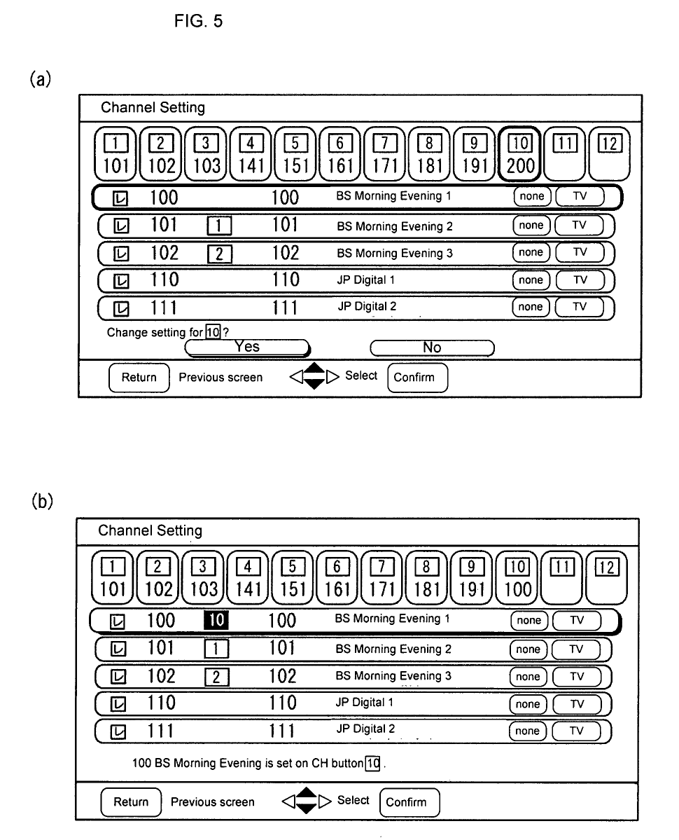

FIG. 5(a) shows that the square frame of “10” on the screen portion of the channel preset setting is selected for the confirmed selection narrow frame (the frame described with 100ch) on the screen portion of the channel skip setting. And this screen shows a message “Change setting for “10”?”, a “yes” button, and a “no” button. In addition, at this point, 200ch is allocated to the square frame (numeric key) of “10”. When the CPU 13 detects the confirmation in this condition, the CPU 13 performs a change process for the channel setting.

FIG. 5(b) is an illustration showing a condition that the change process for the channel setting is performed. That is, the description of “10” is added to the confirmed selection narrow frame (the frame described with 100ch) on the screen portion of the channel skip setting, and “100 ch” is described in the square frame of “10” on the screen portion of the channel preset setting. In this example, the CPU 13 allocates BS morning evening channel 1 (100ch) on “10”, that is, a numeric key (channel button). This allocated information is stored in the memory 14 as the channel setting information.

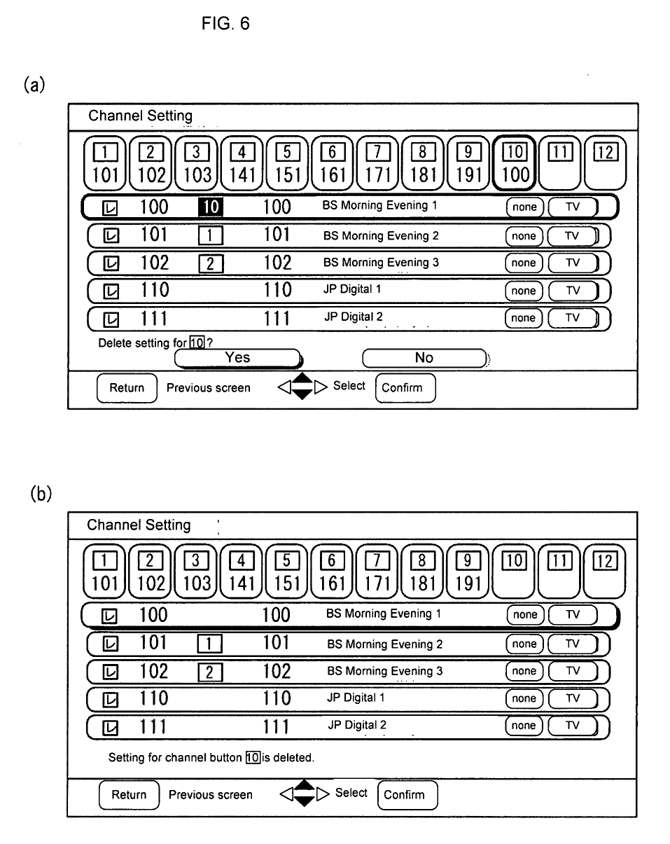

FIG. 6(a) shows an example of a message “delete setting of “10”?”, a “yes” button, and a “no” button against the selection narrow frame that has already preset (The frame described with “100” in this figure, and preset to “10”). When the CPU 13 detects the confirmation operation is performed in the condition that the “yes” button is selected, the CPU 13 performs a change process of the channel setting, that is, excluding the designated channel from the preset subject.

FIG. 6(b) is an illustration showing a condition that the change (delete) process of the channel setting is performed. That is, the description of “10” is deleted from the confirmed selection narrow frame (the frame described with 100ch) on the screen portion of the channel skip setting, and the description of “100ch” is deleted from the square frame of “10” on the screen portion of the channel preset setting. In this example, the CPU 13 deletes the information which allocates the BS morning evening channel 1 (100ch) to “10”, that is a numeric key (channel button), from the memory 14.

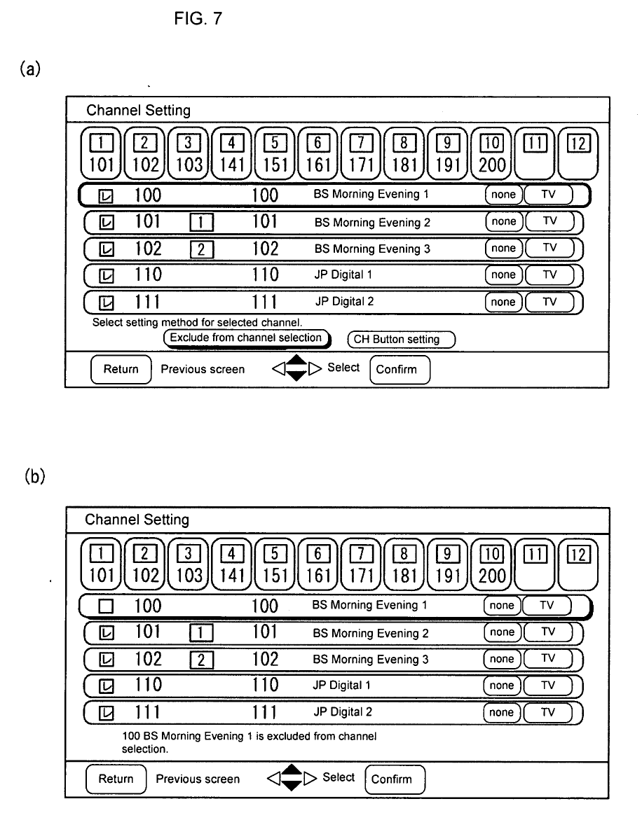

FIG. 7(a) is equivalent to the condition that the “exclude from channel selection subject” button is selected in the screen of FIG. 4(b). When the CPU 13 detects the confirmation operation is performed in the condition that the “exclude from channel selection subject” button is selected, performs a process to apply a skip setting (exclude from channel selection subject) to the pertinent channel.

FIG. 7(b) shows that the confirmation operation is performed while the “exclude from channel selection subject” button is selected. In this screen, the mark (check) is removed from the check box of the confirmed selection narrow frame (the frame described with 100ch). The CPU 13 rewrites the information in the channel setting information on the memory 14 to exclude the 100ch from the channel selection subject at the channel up/down selection.

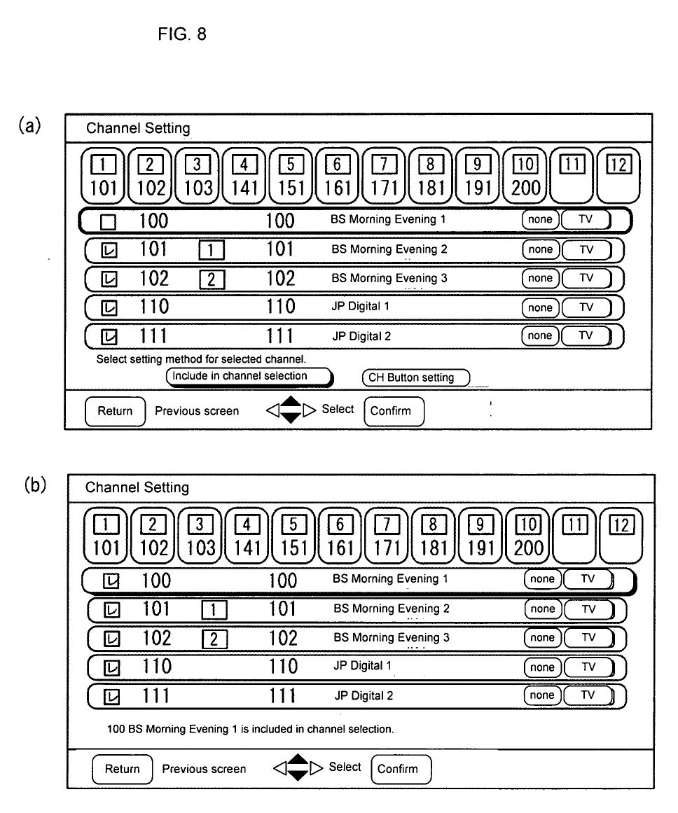

FIG. 8(a) shows an example of the condition that the mark (check) is removed from the check box of the selection narrow frame (the frame described with 100ch). In such a case, instead of the “exclude from channel selection subject” button, an “include in channel selection subject” is displayed. When the CPU 13 detects the confirmation operation is performed in the condition that the “include in channel selection subject” button is selected, it performs a process to return the pertinent channel to a channel selection subject.

FIG. 8(b) shows a condition that the confirmation operation is performed while the “include in channel selection subject” button is selected. In this screen, a mark (check) is added to the check box of a confirmed selection narrow frame (the frame described with 100ch). In order to include the 100ch in the channel up/down, the CPU 13 rewrites the information to the channel setting information on the memory 14 to include the 100ch in the subject of channel up/down of channel selection.

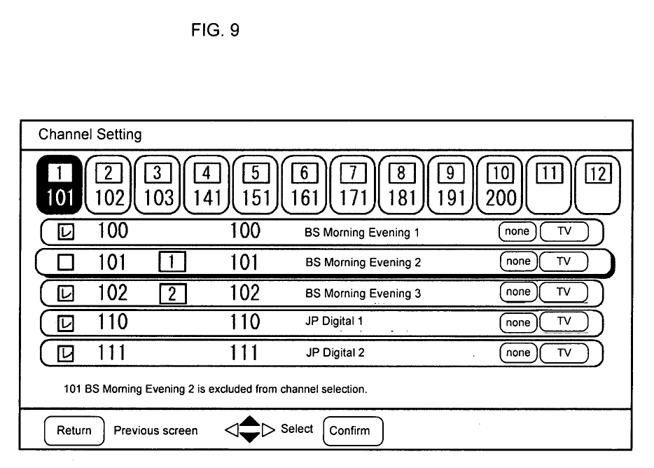

FIG. 9 shows a condition that a confirmation operation is performed after the “exclude from channel selection subject” button is selected while the narrow frame (the frame described with 101ch) which has the mark in the check box, is selected. The 101ch in the confirmed selection narrow frame (the frame described with 101ch) is a channel preset to the square frame of “1” in the channel preset setting. That is, the condition shown in FIG. 9 is that even though the channel is preset, the channel is excluded from the channel selection subject in the channel skip setting.

When the CPU 13 detects such a condition, the CPU 13 changes the color of characters in the square frame “1” in the channel preset different from those of other square frames, thereby calling an attention of the user. This caution is equivalent to “the channel applied the channel preset is excluded from the channel selection subject in the channel skip setting. Isn't this an unfavorable setting?” In addition, a display of “101 ch will be skipped” may further be displayed. Also, an audio guide memory may be provided, that stores audio data, such as, “There is a channel that is designated to skip although it is preset”, in the memory, and an audio guide may be provided by this audio data. Also, the display to call an attention that is not limited to the change in the color of characters in the square frame, it may be expressed by a change of the frame color or the color in the frame, or a change in form of the frame or font of the character in the frame.

Also, in the above example, it is configured to call an attention to a user when the user designates to skip a channel in the channel skip setting while the channel is allocated to a numeric key in the channel preset setting, however, it is not limited to this. It may be configured to call an attention to a user when a channel is allocated to a numeric key in the channel preset setting while the channel is designated to skip in the channel skip setting.

Also, the channel designated to skip is excluded from the channel up-down selection subject, however, it is not limited to this. In the EPG (electronic program guide), the channel designated to skip may be excluded from the subject for displaying in the electronic program guide.

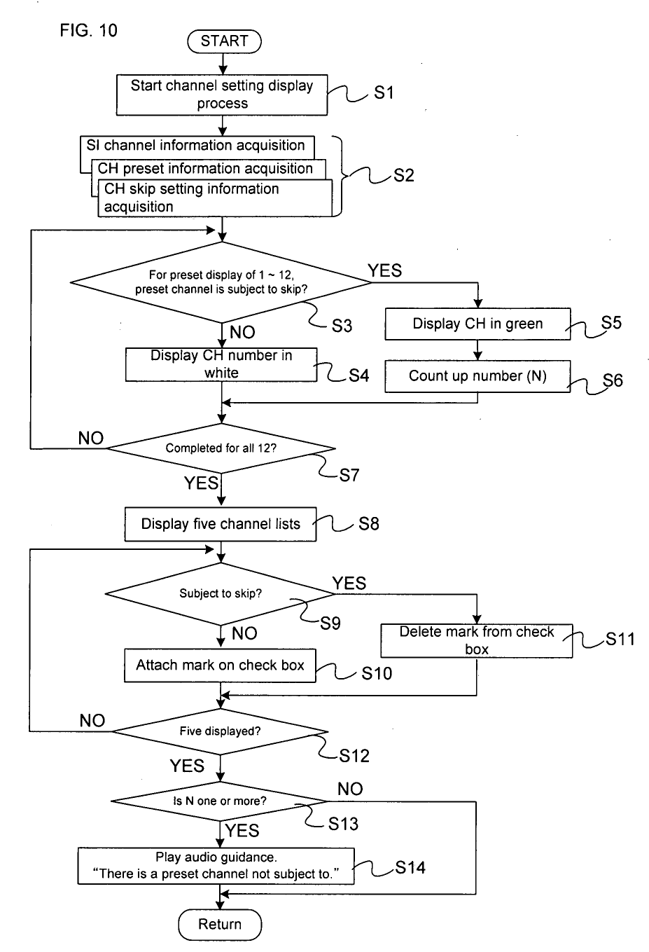

FIG. 10 is a flowchart of an example of a process when the channel preset setting/channel skip setting common screen is displayed.

As the CPU 13 receives an instruction to start a process of the common screen (channel setting display screen), and performs a channel information acquisition process, a channel preset information acquisition process, and a channel skip setting information acquisition process in the S1 (service information) (step S2). That is, the CPU 13 reads out each information from the memory 14. Next, the CPU 13 performs a channel preset display of 1 to 12 on the screen portion of the channel preset setting, and determines as to whether the preset channel is subject to skip or not in order to decide the display color of the channel (step S3). When it is not subject to skip, the channel number is described in white (step S4). On the contrary, when it is subject to skip, the channel number is described in green (step S5), and counts up the number (N) of channels subject to skip (step S6). Next, a determination is made to all the channels 1 to 12 as to whether a skip subject judgment was performed or not (step S7). If not, return to the step S3, or if it is performed to all, proceed to step S8.

In the step S8, a display of channel list portions (a display of channel skip setting screen portion) is performed. At this time, the number of channels displayed which can be shown in the screen is five (refer to FIG. 4). Then, in this display process, a determination as to whether the channel which is subject to the above display is subject to a skip or not (step 9). If it is not subject to skip, apply a mark in the check box (step S10), and if it is subject to skip, remove the mark from the check box (step S11).

And, a determination is made as to whether the mark indication of the check boxes for above five channel lists is completed or not (step S12). If not, return to step S9, and if completed, determine whether the above described number (N) is one or more (step S13). When N is one or more, replay the audio guidance (sound output such as, “There is a preset channel not subject to channel selection”) (step S14). In addition, when the CPU 13 detects, for example, pressing of the down direction key, perform the scroll process and display the next channel list. At this time, the processes equivalent to steps S9 to S12 are performed.

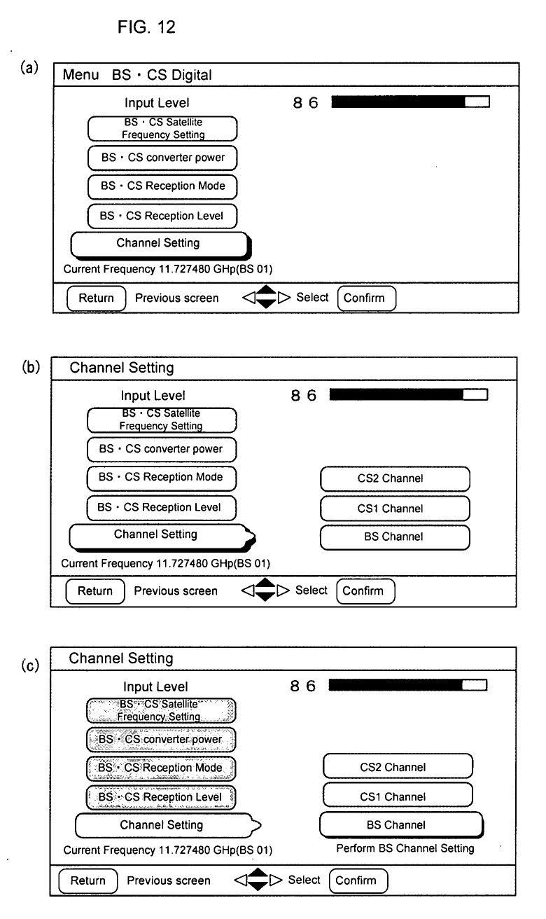

By the way, a conventional screen corresponding to the screen shown in FIG. 3(c) is described in FIGS. 12(a), (b), and (c). That is, as the right direction key is pressed in the screen of FIG. 12(a), subordinate items appear as shown in FIG. 12(b) (arranged in the upper most position or the lower most position among the subordinate items right next to the selected superordinate items). At this time, the superordinate items that are not selected remain, and the position of selected superordinate items remains. And, when the right direction key is further pressed in this screen condition, the cursor moves to the subordinate items side as described in FIG. 12(c). And the items that are not selected in the superordinate items are described in halftone (a lighter display color). In addition, selection of the subordinate items is performed by using the up/down direction key. However, in the display to show the screen prompting such item selection to a user, when the display position of the selected superordinate item is maintained while the unselected superordinate items remain as described above, it provides a positional limitation in displaying the subordinate items, thereby decreasing the visibility of items for a user. On the contrary, in the configuration to delete the display of unselected superordinate items and to change the display position of selected superordinate items as shown in FIG. 3(c) (it is preferable to arrange the upper most or the lower most position of the subordinate items right next to the display position of the selected superordinate item), the limitation in displaying the subordinate items is decreased, thereby increasing the visibility of items for a user.

That is, when an operation to select and confirm a superordinate item in a configuration to display superordinate items (buttons) and subordinate items (buttons) on the menu screen, it is preferable to configure so that the superordinate items other than that selected and confirmed items are to be deleted. Further, in such a configuration, the display position of the superordinate item that is selected and confirmed is preferably changed within the superordinate item display area. In these configurations, it is preferable that the superordinate item that is selected and confirmed to be arranged right next to the subordinate item positioned in an upper most position. Alternatively, the superordinate item that is selected and confirmed may be arranged right next to the subordinate item position in the middle. Further, in these configurations, the superordinate item that is selected and confirmed may be changed from an original button like display (a display with a frame) to a display which is not recognized as a button as shown in FIG. 3(c). When button like displays (displays with a frame) for superordinate items and subordinate items appear, the screen displays a lot of buttons so it is difficult to see, thus, changing the superordinate item that is selected and confirmed to a display which is not recognized as a button making the display easily seen by a user.

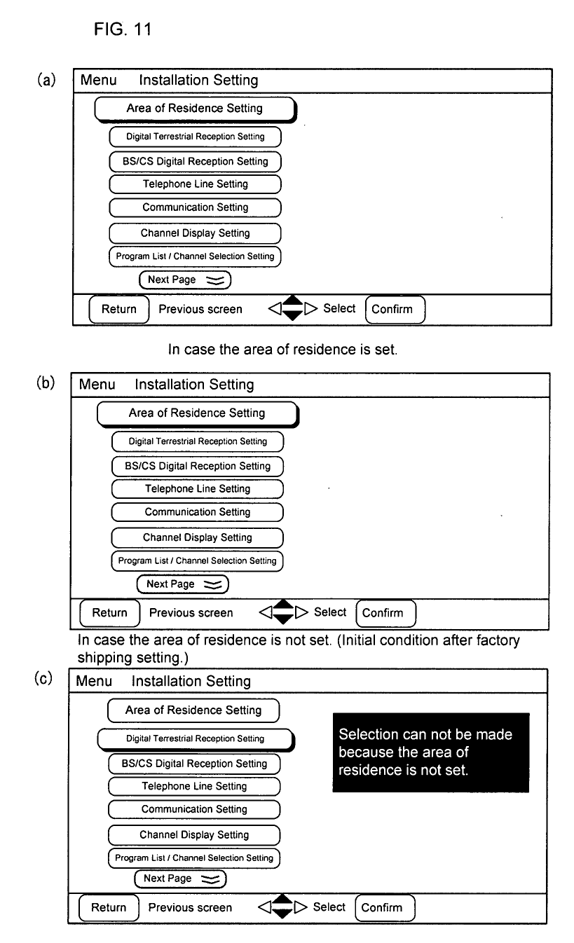

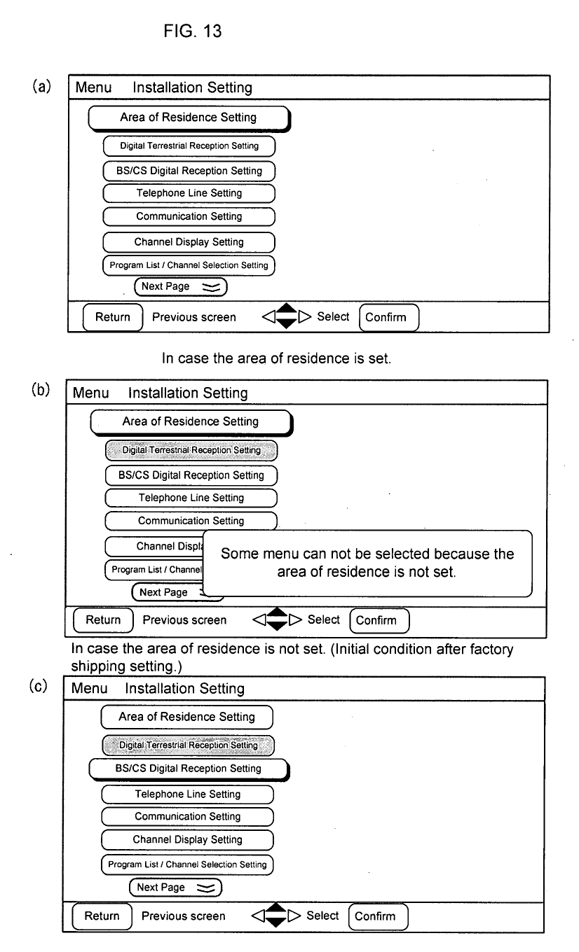

Also, FIGS. 11(a), (b), and (c) shows examples of screen displays when “installation setting” is selected from the menu items. In addition, FIGS. 13(a), (b), and (c) shows conventional examples corresponding to this display screen. At this time, when the area of residence is not set, the digital terrestrial reception setting can not be performed. FIG. 13(a) shows a case where the area of residence is set, and FIG. 13(b) shows a case where the area of residence is not set. Conventionally, as shown in FIG. 13(b), the “digital terrestrial reception setting” button which can not be selected is presented in halftone in the screen of “installation setting”, and further a message of “there is a menu which can not be selected because the area of residence is not set” is also shown. And pressing the down direction key in the condition of screen in. FIG. 13(b), the cursor skips the button of “digital terrestrial reception setting”, and moves to the button of “BS/CS digital reception setting”.

If the screen display is as shown in FIG. 13, a user sees that the color of a certain button is different from others right at the very first screen for the “installation setting”, thus the user may wonder why the color of the button of “digital terrestrial reception setting” is changed even though no operation is made on the screen of “installation setting”, or it can be thought that the corresponding relation of the change in color of the button and the message is difficult to understand.

On the other hand, in the display examples shown in FIGS. 11(a) (b), and (c), there is no difference in displays for the FIG. 13(a) which shows a case where the area of residence is set, and the FIG. 13(b) which shows a case where the area of residence is not set. That is, even when there is a button that can not be set at that point, it is displayed the same as the other buttons (not in halftone). And, when the down direction key is pressed in the condition of the screen in FIG. 11(b), the cursor moves to the button of “digital terrestrial reception setting” positioned right below the “area of residence setting”. That is, the cursor does not skip. Then, a message to state the reason for unable to set appears at this time (when the cursor is placed in the button that can not be set at that point). In this way, a user receives the message for the operation performed by himself or herself, thereby it is easier to understand the correspondence of the performed operation and the message. In addition, in this embodiment, the form of display is different from the normal display (color of font, background color, size of font) and is employed for the display of a message.

That is, in the configuration to display superordinate items (buttons) and subordinate items (buttons) simultaneously on the menu screen, it is preferable that a superordinate item that can not be selected at that point is displayed in a form the same as those of other superordinate items, as well as displaying a cursor in a form the same as those of other superordinate items when the cursor moves to the superordinate item that can not be selected at that point, and further displays a message to indicate the reason why the superordinate item can not be selected. In such a configuration, the display of the message is preferably made in a form different from the normal display.

What is claimed is:

1. A broadcasting receiver for performing both a channel preset setting to allocate a channel on a numeric key on a remote controller or a main body, and a channel skip setting to exclude a channel that is designated to skip from a subject of an up/down channel selection,
wherein said broadcasting receiver comprising a means for displaying a first listing screen reflecting a condition of channel allocation to each numeric key in said channel preset setting and a second listing screen reflecting a condition of the skip setting to a channel in said channel skip setting; and
a means for reflecting an instruction from a user on said first listing screen and said second listing screen while said first listing screen and said second listing screen are displayed.

2. The broadcasting receiver according to claim 1, the broadcasting receiver comprising a means for displaying an electronic program guide according to a program information to show contents of programs;
wherein said channel designated to skip is excluded from a subject for display in said electronic program guide.

3. The broadcasting receiver according to claim 1, wherein said broadcasting receiver shows a display for calling an attention of a user on said screen when the user designates a channel to skip in said channel skip setting while the channel is allocated to a numeric key in said channel preset setting.

4. The broadcasting receiver according to claim 1, wherein said broadcasting receiver shows a display for calling an attention of a user on said screen when a channel is allocated to a numeric key in said channel preset setting while the channel is designated to skip in said channel skip setting by the user.

5. The broadcasting receiver according to claim 3, wherein the display to call attention is performed by changing a form of a frame or a display within the frame and shows the condition of channel allocation of each numeric key on said first listing screen display different from the form of other frames or displays within the frame.

6. The broadcasting receiver according to claim 4, wherein the display to call attention is performed by changing a form of a frame or a display within the frame and shows the condition of channel allocation of each numeric key on said first listing screen display different from the form of other frames or displays within the frame.

7. The broadcasting receiver according to claim 3, wherein said broadcasting receiver performs an audio guidance to indicate that an operation is unfavorable along with said display to call attention.

8. The broadcasting receiver according to claim 4, wherein said broadcasting receiver performs an audio guidance to indicate that an operation is unfavorable along with said display to call attention.
